(19) United States
(12) Patent Application Publication
(10) Pub. No.: US 2003/0161929 A1
(43) Pub. Date: Aug. 28, 2003

(54) Method for manufacturing cold/hot elastic gel

(76) Inventor: Kuo-Liang Chen, Hsin-Tein City (TW)

Correspondence Address: BACON & THOMAS, PLLC, 625 SLATERS LANE, FOURTH FLOOR, ALEXANDRIA, VA, 22314

(21) Appl. No.: 10/084,427

(22) Filed: Feb. 28, 2002

(51) Int. Cl. A23L 1/05; A23L 1/06

(52) U.S. Cl. 426/573

(57) ABSTRACT

Method and material for manufacturing cold/hot elastic gel, in which synthesized vegetal glue and high order starch are mixed at a certain ratio and fully stirred into an even state. Then a certain amount of water is added into the mixture and stirred to an even state to produce flour mash-like sticky mass by various processing tools or human hands. The solution is at the same time heated to a certain temperature. During heating, the chemical bonds of the molecules of the materials are chemically changed to form thermally irreversible gel. The materials are blended into flour mash-like sticky mass. After rested and cooled, the sticky mass processed by various processing measures into gel foods which can be frozen and refrigerated. The elasticity of the gel foods in hot state is equal to the elasticity of the gel in cold state. The gel foods can be further steamed or cooked for eating.

### BACKGROUND OF THE INVENTION

The present invention is related to a method for manufacturing cold/hot elastic gel. In the manufacturing method, specific materials such as aqueous solution of synthesized vegetal glue and high order starch are processed through a certain procedure to produce cheap elastic gel food which can be frozen and refrigerated. The elasticity of the gel in hot state is equal to the elasticity of the gel in cold state.

Various meat-simulative vegetable foods have been developed and commercialized, including stuffed dumplings made of glutinous rice flour, vegetarian gelatin, soybean jelly, fruit jelly, and almond jelly, etc. Most of these meat-simulative vegetable foods are made of carrageenan.

The carrageenan is a natural polysaccharide vegetal glue extracted from red alga. In general, the carrageenan is white or light yellow powder free from any odor and smell. The gel formed from the carrageenan is thermally reversible, that is, when heated, the gel will be molten into a solution. When cooled, the solution is again curdled into gel. The carrageenan is well resoluble in water. The carrageenan starts to resolve at 70° C. and completely resolves at 80° C. The dry powdered carrageenan is quite stable and durable without quick hydrolysis. The carrageenan is more stable than fruit glue and brown alga glue. Also, the carrageenan is quite stable in neutral and alkaline solution and even heated, the carrageenan will not be hydrolyzed. The carrageenan is a hydrophilic glue which can be gelled, curdled, thickened, emulsified and stably distributed. The carrageenan is widely used in the fields of milk-made products, soft ice creams, fruit beverages, breads, fruit jellies, meat-made foods, sauces, canned foods, etc. However, the carrageenan is thermally reversible so that the carrageenan-made products cannot be frozen or refrigerated. Moreover, the carrageenan-made products are likely to become tender and deform after boiled for a long time. Therefore, it is hard to reproduce and process the carrageenan-made products and the utility thereof is limited.

### SUMMARY OF THE INVENTION

It is therefore a primary object of the present invention to provide a method for manufacturing a cheaper purely vegetal gel. According to the manufacturing method, synthesized vegetal glue and high order starch and water are mixed at a certain ratio and fully stirred into an even state. The solution is at the same time heated to a certain temperature and then cooled and processed to form gel foods. Thus providing low calorie, cholesterol free and high fiber material for making healthy desert.

It is a further object of the present invention to provide the above method in which during heating, the chemical bonds of the molecules of the materials are chemically changed to form thermally irreversible gel. The gel can be frozen and refrigerated. The elasticity of the gel foods in hot state is equal to the elasticity of the gel in cold state. The gel foods can be further steamed or cooked for eating.

According to the above objects, the high fiber vegetal glue and high order starch are mixed at a ratio of about 1:2 and stirred into an even state. Then a certain amount of water is added into the mixture and stirred to an even state to form flour mash-like sticky mass and molded by multi-processing measures. At the same time, the solution is heated to about 85° C. During heating, the molecule structures of the materials are destroyed and the chemical bonds are bonded with each other to form thermally irreversible gel. The elasticity of the gel foods in hot state is equal to the elasticity of the gel in cold state. It can be edible or for commercialized in packages.

The above embodiment is only used to illustrate the present invention, not intended to limit the scope thereof. Many modifications of the above embodiment can be made without departing from the spirit of the present invention.

The present invention can be best understood through the following description and accompanying drawings wherein:

### BRIEF DESCRIPTION OF THE DRAWINGS

FIG. 1 is a manufacturing flow chart of the present invention.

### DETAILED DESCRIPTION OF THE PREFERRED EMBODIMENTS

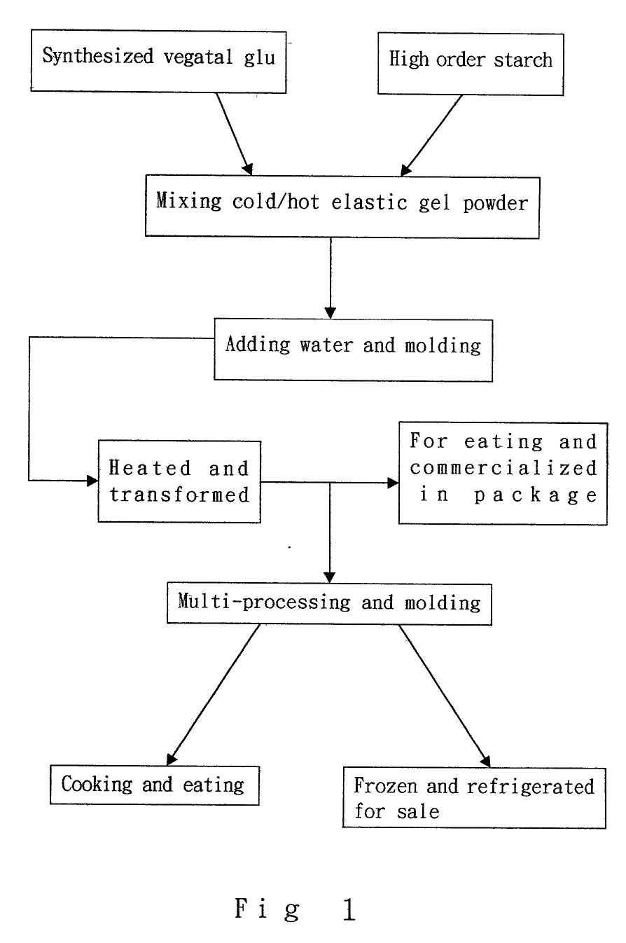

Please refer to FIG. 1. The method for manufacturing cold/hot elastic gel of the present invention is for producing cheap elastic gel foods. The gel foods made by the present invent ion are thermally irreversible and can be frozen and refrigerated, as where as traditional desert could not be further steamed or cooked. The elasticity of the gel foods in hot state is equal to the elasticity of the gel in cold state. The gel foods can be repeatedly cooked without becoming tender.

The manufacturing method for cold/hot elastic gel of the present invention includes steps of:

1.Materials:

preparing and mixing materials, the materials including high fiber vegetal glue, high order starch and hot water, in this embodiment, the ratios of the respective materials being synthesized vegetal glue—35%, high order starch—65% and a certain amount of water;

2.Manufacture:

(a) cold/hot elastic gel powder

heating and stirring the materials, the above synthesized vegetal glue and high order starch being mixed at a ratio of about 1:2 and stirred into an even state,

(b) adding water and molding

a certain amount of water being added into the mixture and stirred to an even state, put together into the stirrer and speed it up for producing flour mash-like sticky mass, molded by hand or devices;

(c) heated and transformed

the solution being heated to about 85° C. (about 30 minutes) to destroy the internal molecule structure of the materials and make the chemical bonds of the materials bond with each other, as a result forming thermally irreversible gel

(d) edible instantly or sale in package

the gel could be edible in one's taste or commercialized after frozen and package means;

(e) processing and molding the materials

the flour mash-like sticky mass being pressed or rolled into necessary semi-products by various processing tools. By steps stated previously to transform primitive thermally irreversible product, the semi-products being steamed or cooked or going through other manufacturing procedures to form complete food products such as meat-simulative vegetable foods, ice creams, gel snacks, fruit jellies, rice glue balls, ice bars, soft candies, etc.;

(f) cooking and eating the products.

The present invention is able to achieve the aforesaid effects mainly due to the step of heating and stirring the materials.

The principle is as follows:

The synthesized vegetal glue and high order starch are mixed at a ratio of about 1:2 and stirred into an even state. Then a certain amount of water is added into the mixture and stirred to an even state. To form flour mash-like sticky mass, the solution is heated to about 85° C. During heating, the hot water infiltrates into and destroys the fiber tissues (molecule chemical bonds) of the high fiber vegetal glue and high order starch. Moreover, voids are formed in the materials to make the chemical bonds thereof more easily bond with each other. The materials thus form thermally irreversible gel which can be further processed into gel foods. The gel foods made by the present invention are cheap and can be frozen and refrigerated. The elasticity of the gel foods in hot state is equal to the elasticity of the gel in cold state. The gel foods can be durably cooked without becoming tender so that the appearance and taste of the gel foods are excellent.

What is claimed is:

1. Method for manufacturing cold/hot elastic gel comprising steps of:
(a) mixing cold/hot elastic powder
(b) adding water and molding
(c) heated and transformed
(d) edible instantly or sale in package
(e) processing and molding the materials
(f) cooking and eating the products

2. Method for manufacturing cold/hot elastic gel as claimed in claim 1, wherein the materials at least include synthesized vegetal glue, high order starch and water.

3. Method for manufacturing cold/hot elastic gel as claimed in claim 1, wherein the synthesized vegetal glue and high order starch are mixed at a ratio of about 1:2 in which the synthesized vegetal glue is 35% of the mixture, while the high order starch is 65% of the mixture.

4. Method for manufacturing cold/hot elastic gel as claimed in claim 1, wherein the heating solution of the materials is heated to about 85° C.
